(19) United States
(12) Patent Application Publication
(10) Pub. No.: US 2026/0048636 A1
(43) Pub. Date: Feb. 19, 2026

(54) CAMPER TRAILER OR CARAVAN

(71) Applicant: Patriot Campers Holdings Pty Ltd, Molendinar (AU)

(72) Inventors: Justin Montesalvo, Molendinar (AU); Mitchell Bell, Molendinar (AU); Harrison Bell, Molendinar (AU)

(21) Appl. No.: 19/270,652

(22) Filed: Jul. 16, 2025

(30) Foreign Application Priority Data
Aug. 16, 2024 (AU) 2024902557
Feb. 14, 2025 (AU) 2025900407

(51) Int. Cl. B60G 21/10; B60D 1/06; B60G 7/00; B60G 7/02; B60G 11/27; B60P 3/32; B60T 1/06

(52) U.S. Cl. CPC B60G 21/103; B60D 1/06; B60G 7/008; B60G 7/02; B60G 11/27; B60G 2202/242; B60G 2204/143; B60G 2300/04; B60P 3/32; B60T 1/065

(57) ABSTRACT

Provided is a towable accommodation to be towed by an automobile. The towable accommodation includes a chassis, and one or more wheel stabilizer arrangements for mounting to the chassis. Each wheel stabilizer arrangement includes: a flank arm for movably fastening to a flank of the chassis, a mount for mounting to the flank arm and to which a wheel can be rotationally mounted, and a stabilizer for stabilizing the orientation of the wheel as the wheel moves relative to the chassis.

### TECHNICAL FIELD

The present invention generally relates to a camper trailer or a caravan.

### BACKGROUND

The reference to any prior art in this specification is not, and should not be taken as an acknowledgement or any form of suggestion that the prior art forms part of the common general knowledge.

Camper trailers and caravans are both towable accommodation to be hooked up to an automobile and towed to a campsite. The automobile is the prime mover, whereas caravans and camper trailers are non-motorised and passively pulled behind the automobile.

Smaller than a caravan, a camper trailer generally contains a tent that folds out of the trailer, where other living equipment is packed. Its appeal comes from it being light and compact.

The preferred embodiment provides a camper trailer suited to towing over rough terrain and through the bush.

### SUMMARY OF THE INVENTION

According to one aspect of the present invention, there is provided towable accommodation to be towed by an automobile, the towable accommodation including:
a chassis; and
one or more wheel stabilizer arrangements for mounting to the chassis, each wheel stabilizer arrangement including:
   a flank arm for movably fastening to a flank of the chassis;
   a mount for mounting to the flank arm and to which a wheel can be rotationally mounted; and
   a stabilizer for stabilizing the orientation of the wheel as the wheel moves relative to the chassis.

Advantageously, the stabilizer may stabilize the wheel in a substantially vertical orientation as the flank arm moves relative to the chassis when towing the accommodation over rough terrain and through the bush.

Each stabilizer arrangement may include a wheel hub assembly for rotationally mounting the wheel to the mount. The chassis may terminate in a coupler for coupling to a tow ball of the automobile.

The stabilizer may include an adjuster to adjust the orientation of the wheel. The adjuster may adjust the length of one or more arms of the stabilizer. The adjuster may include one or more cam arrangements for adjusting the arms to a required length.

Each wheel stabilizer arrangement may include a suspension. The suspension may include an airbag. An arm of the stabilizer may include an airbag seat from which the airbag extends. The suspension may include a shock absorber. The shock absorber may be a gas shock absorber.

The stabilizer may include one or more control arms extending between the chassis and the mount. The stabilizer may further include a stabilizer arm extending between the chassis and the mount. The control arms and stabilizer arm may be located behind a wheel axis. The control arms may include an top control arm and a bottom control arm. The stabilizer arm may be located between the top control arm and bottom control arm. The stabilizer arm may be located behind the control arms. The stabilizer arm may extend outwardly beyond the control arms.

The mount may be fastened to the control arms and the stabilizer arm. The mount may be fastened to the flank arm. The stabilizer may include a sway bar for coupling to the control arms.

The control arms and stabilizer arm may be mounted at each end using respective resilient bushes. The flank arm may be pivotally fastened to the chassis, preferably using a resilient bush. The mount may be resiliently mounted to the flank arm, preferably using one or more resilient bushes.

The wheel stabilizer arrangement may include a brake arrangement. The brake arrangement may include a brake disk, and a calliper for engaging with the disk. The wheel hub assembly may include a hub to which the wheel is fastened.

The mount may include a knuckle.

The towable accommodation may include one or two pairs of wheel stabilizer arrangements. The towable accommodation may include a non-motorised camper trailer, caravan or hybrid.

According to one aspect of the present invention, there is provided towable accommodation to be towed by an automobile, the towable accommodation including:
a chassis; and
one or more wheel stabilizer arrangements for mounting to the chassis, each wheel stabilizer arrangement including a stabilizer for stabilizing the orientation of a wheel as the wheel moves relative to the chassis.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a lower rear perspective view of a hybrid camper trailer in accordance with an embodiment of the present invention;

FIG. 2 is a schematic rear view showing operation of a wheel stabilizer arrangement of FIG. 1, with the solid lines showing a default wheel configuration and the dashed lines showing a lifted or lowered wheel configuration;

FIG. 3 is an exploded rear perspective view of the wheel stabilizer arrangement of FIG. 2;

FIG. 4 is a rear perspective view showing mounting of the assembled wheel stabilizer arrangement;

FIG. 5A shows a plan view of a wheel stabilizer arrangement of FIG. 1 in a default wheel configuration;

FIG. 5B shows a rear view of the wheel stabilizer arrangement of FIG. 5A in a default wheel configuration;

FIG. 6A shows a plan view of a wheel stabilizer arrangement of FIG. 1 in a lowered wheel configuration;

FIG. 6B shows a rear view of the wheel stabilizer arrangement of FIG. 6A in a lowered wheel configuration;

FIG. 7 shows a rear perspective view showing four wheel stabilizer arrangements;

FIG. 8 is an exploded rear perspective view of a wheel stabilizer arrangement in accordance with another embodiment;

FIG. 9 shows front and rear views of the wheel stabilizer arrangement of FIG. 8;

FIG. 10 shows front views of opposed wheel stabilizer arrangements of FIG. 8 undergoing different wheel bump conditions;

FIG. 11 shows an adjustment arrangement for control arms; and

FIG. 12 shows mounting of the wheel stabilizer arrangement of FIG. 8.

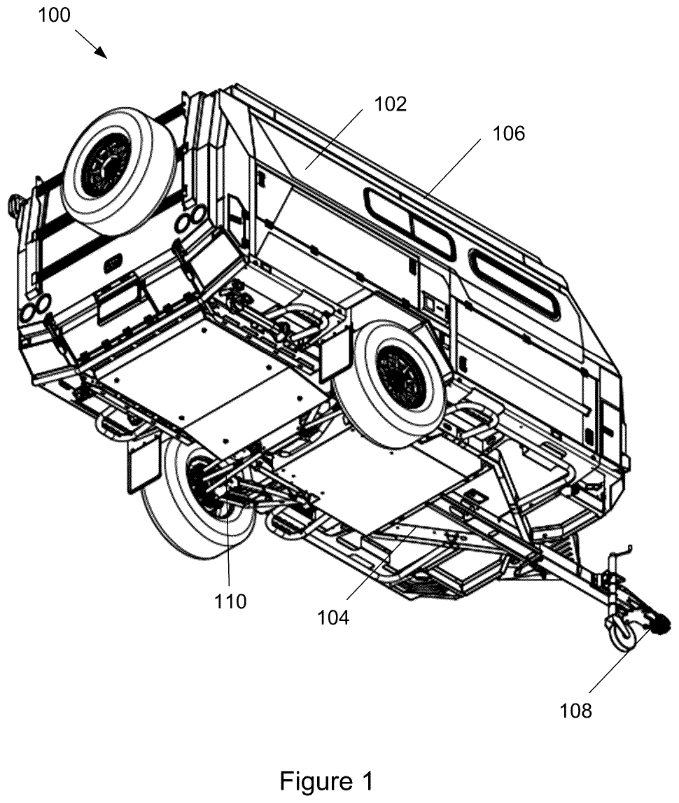

### DETAILED DESCRIPTION OF PREFERRED EMBODIMENTS

According to an embodiment of the present invention, there is provided a hybrid camper trailer 100 (i.e. towable accommodation) which is to be towed by an automobile such as a four wheel drive (4WD). The hybrid camper trailer 100 has four hard sides 102 extending up from a frame chassis 104, and a pop-top 106 extending up from the sides 102. The chassis 104 terminates in a tongue coupler 108 for coupling to a tow ball of the 4WD. The hybrid camper trailer 100 also includes a pair of independent wheel stabilizer arrangements 110 for mounting to opposite sides of the trailer chassis 104.

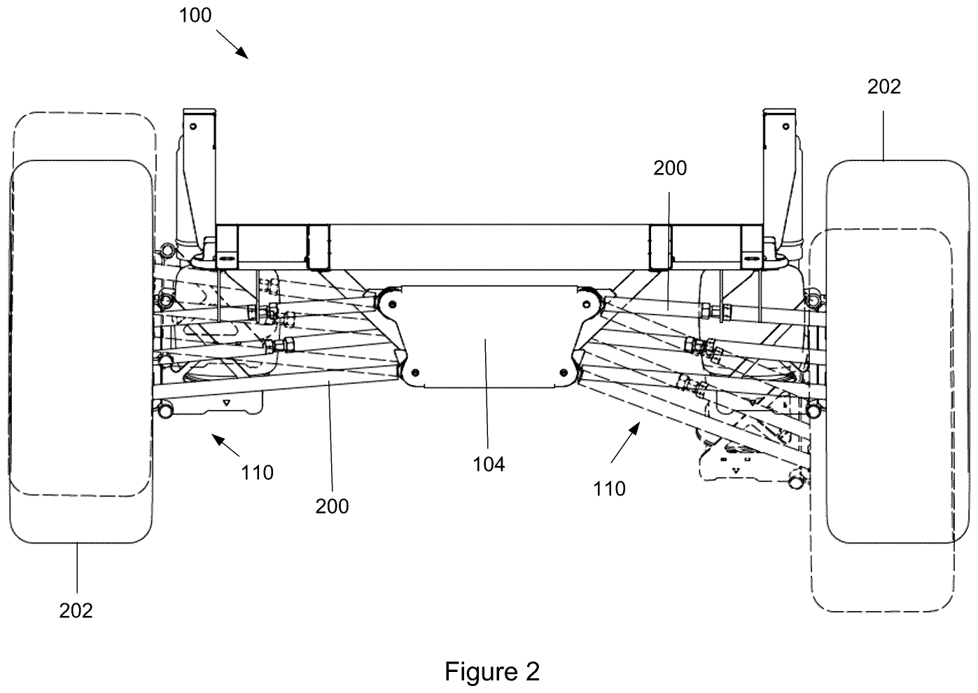

As can best be seen in FIG. 2, each lateral wheel stabilizer arrangement 110 includes a stabilizer 200 for stabilizing the orientation of a wheel 202 as the wheel 202 moves though its vertical stroke relative to the chassis 104. The solid lines in FIG. 2 show a default wheel configuration when the camper trailer 100 is stationary, and the dashed lines show a left-side lifted or right-side lowered wheel configuration in use when towed over rough terrain. Advantageously, as can be seen, the stabilizer 200 stabilizes the wheel 202 in a substantially vertical orientation when towing the camper trailer 100 over rough terrain and through the bush where tracks invariably have trenches formed by wheels.

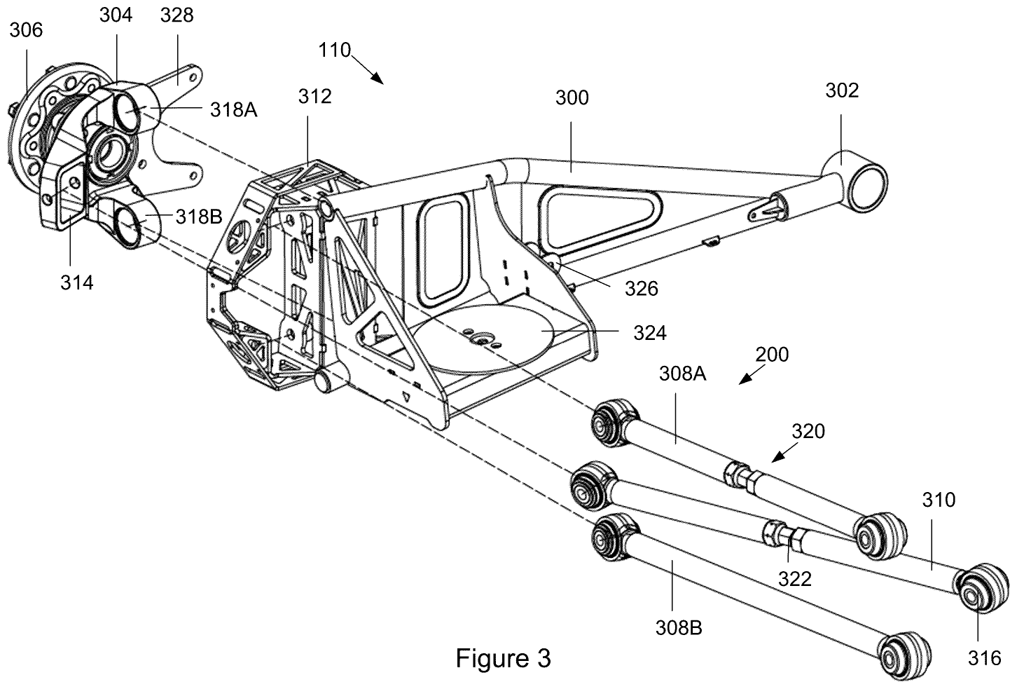

As can best be seen in FIG. 3, each wheel stabilizer arrangement 110 includes a main flank arm 300 for pivotally fastening to and along a flank of the frame chassis 104 about a front sleeve 302. The wheel stabilizer arrangement 110 further includes a knuckle mount 304 for mounting to a rear end of the flank arm 300. Further, the stabilizer arrangement 110 includes a wheel hub assembly 306 for rotationally mounting the wheel 202 to the knuckle mount 304. The stabilizer 200 stabilizes the wheel 202 in a substantially vertical orientation as the flank arm 300 pivots relative to the chassis 104.

The stabilizer 200 includes a top control arm 308A and a bottom control arm 308B, which allow the rear end of the flank arm 300 and therefore the wheel 202 to move up and down. The control arms 308A, 308B are fastened to and extend between the chassis 104 and the rear end of the main flank arm 300. The stabilizer 200 further includes a central toe stabilizer arm 310, located between the control arms 308A, 308B, fastened to and extending between the chassis 104 and the knuckle mount 304.

The control arms 308A, 308B and toe stabilizer arm 310 are located behind the rotational axis of the wheel 202 toward the rear of the camper trailer 100. The toe stabilizer arm 310 extends outwardly to the knuckle mount 304 beyond the control arms 308A, 308B. The rear of the flank arm 300 includes an arm mounting bracket 312 for receiving the control arms 308A, 308B. Instead, the knuckle mount 304 receives the toe stabilizer arm 310 in a cavity 314.

The control arms 308A, 308B and toe stabilizer arm 310 are pivotally mounted at each end using respective resilient rubber bushes 316 through which fastening bolts pass. Similarly, the front sleeve 302 of the main flank arm 300, and top and bottom sleeves 318A, 318B of the knuckle mount 304 receive resilient bushes 316 for resilient pivot mounting.

The stabilizer 200 also includes a two-stage adjuster 320 to adjust the orientation of the wheel 202 when performing a wheel alignment. The adjuster 320 adjusts the length of the top control arm 308A and the toe stabilizer arm 310 of the stabilizer 200. The bottom control arm 308B is of fixed length. Each adjustable arm 308A, 310 includes a central thread-and-nut lock 322 for locking the arms 308A, 310 to a required length.

The main flank arm 300 includes an airbag bracket seat 324 from which an airbag extends, and a shock absorber bracket 326 for mounting a shock absorber. The knuckle mount 304 includes a calliper mount 328 for mounting a brake calliper.

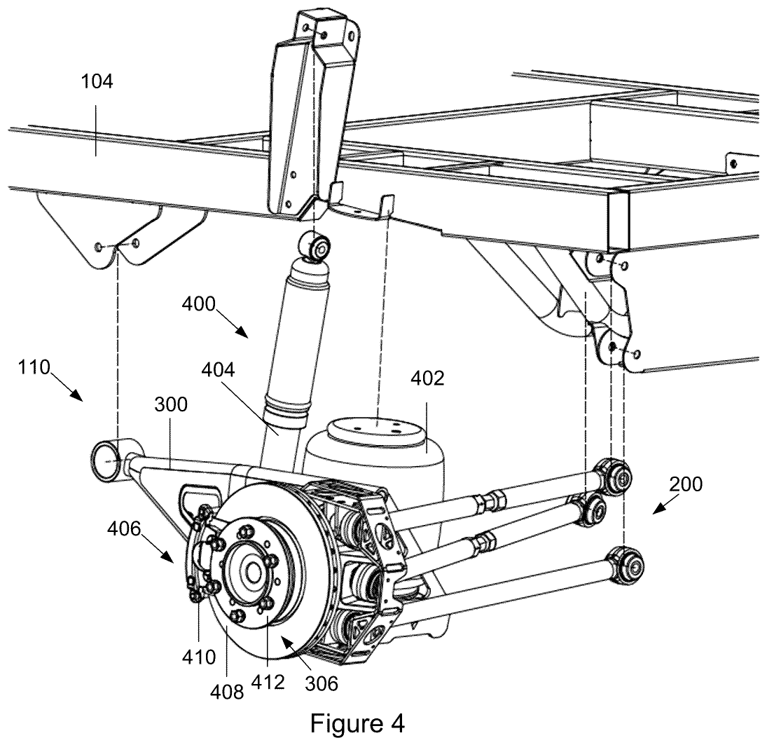

As can best be seen in FIG. 4, each wheel stabilizer arrangement 110 includes a suspension 400. The suspension 400 includes an airbag 402 mounted between the airbag seat 324 of the main flank arm 300 and the frame chassis 104. The suspension 400 also includes a gas shock absorber 404 mounted between the shock absorber bracket 326 of the main flank arm 300 and the chassis 104. The various components 200, 300, 402, 404 can be mounted to the chassis 104 using appropriate brackets.

The wheel stabilizer arrangement 110 includes a brake arrangement 406. The brake arrangement 406 includes a rotational brake disk 408. The brake arrangement 406 also includes a calliper 410, mounted to the calliper mount 328 of the knuckle mount 304, for engaging with the disk 408.

The wheel hub assembly 306 includes a rotating hub 412, with protruding threaded shafts, to which the wheel 202 is fastened. The wheel hub assembly 306 also includes a base for mounting to the knuckle mount 304, and bearings between the base and hub 412 to allow for rotation of the hub 412 relative to the knuckle mount 304.

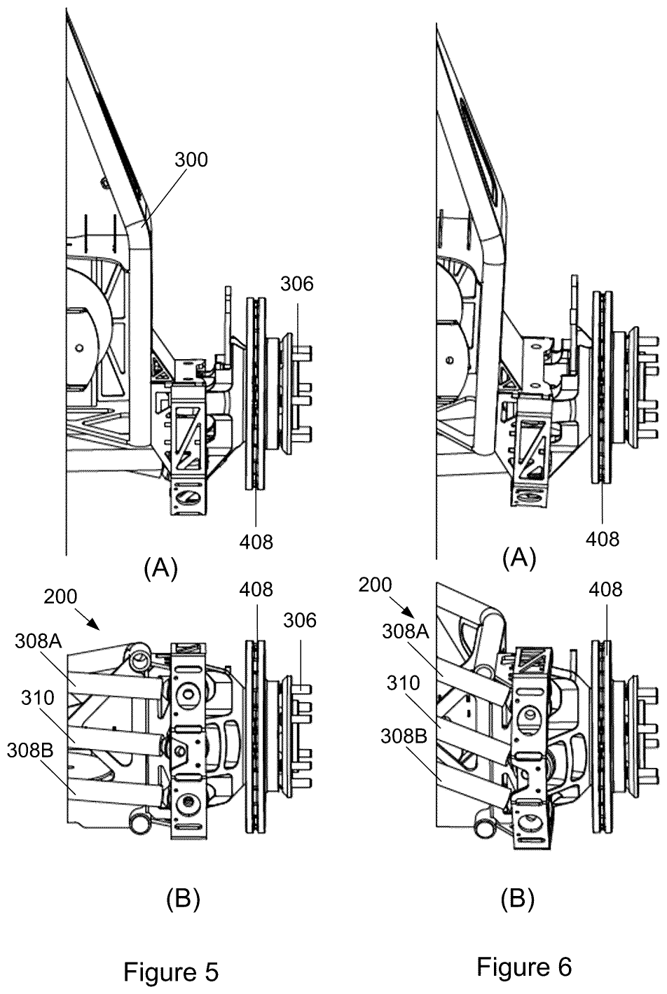

FIGS. 5B and 6B from the rear show the function of the stabilizer 200, from the default wheel configuration when the camper trailer 100 is stationary in FIG. 5B to the lowered wheel configuration in use when towed over rough terrain as shown in FIG. 6B. The stabilizer 200 ensures that the wheel 202, which sits parallel to the brake disk 408, remains substantially vertical throughout the suspension stroke. The parallel control arms 308 and toe stabilizer arm 310 constrain motion of the wheel 202 in a vertical orientation and impede its rotation.

FIGS. 5A and 6A from above, also reaffirm that the wheel 202, which sits parallel to the brake disk 408, remains substantially vertical. The toe angle is the angle of the wheel 202 when viewed from above in FIGS. 5A and 6A, and the stabilizer 200 keeps the toe angle to zero. The toe stabilizer arm 310 keeps the wheels 202 pointing straight throughout the full path of the stroke of the suspension 400. The geometry of the upper control arm 308 (camber link) provides camber angle changes at points of the suspension stroke to result in movement contributing to more desirable handling characteristics of the trailer 100.

A person skilled in the art will appreciate that many embodiments and variations can be made without departing from the ambit of the present invention.

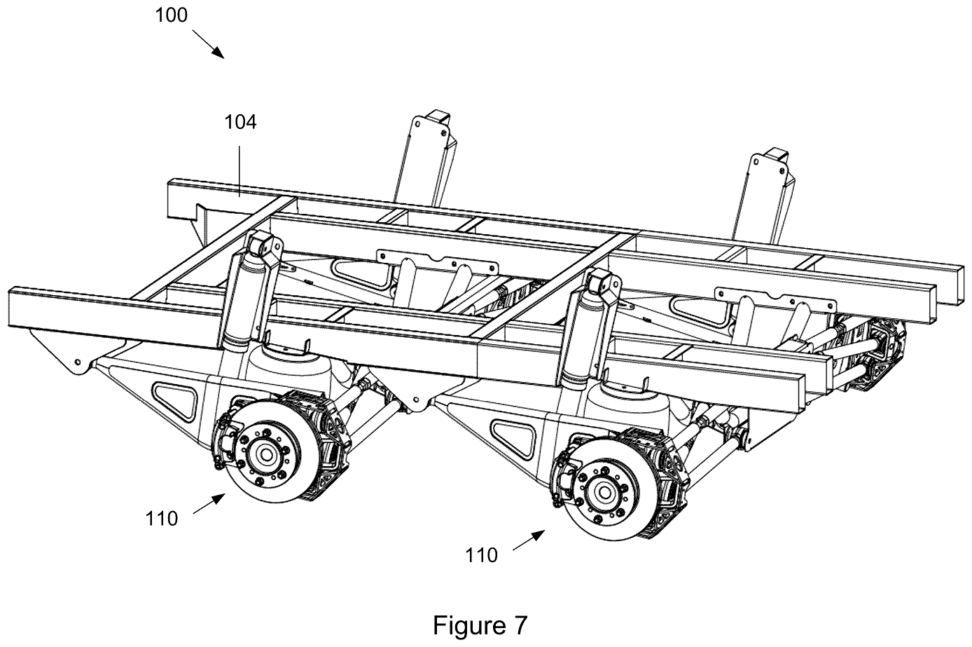

FIG. 7 shows that the hybrid camper trailer 100 can include two pairs of wheel stabilizer arrangements 110.

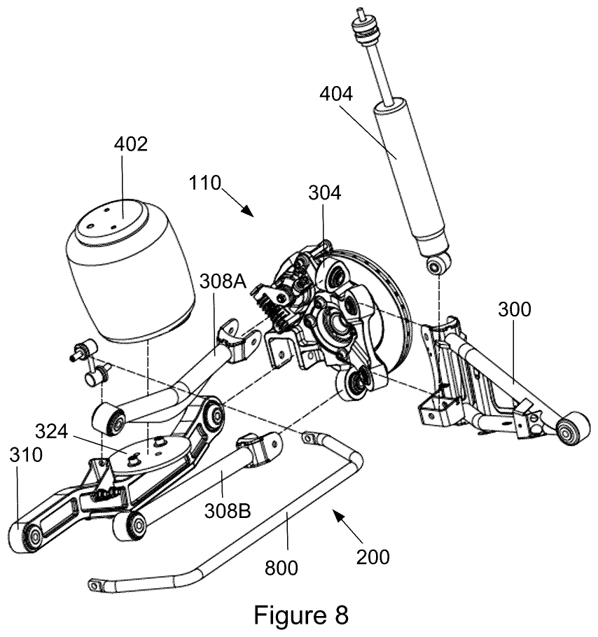

According to another embodiment of the present invention, there is provided a wheel stabilizer arrangement as shown in FIG. 8. Like reference numerals refer to like features previously described.

The wheel stabilizer arrangement 110 includes a flank arm 300 for movably fastening to a flank of the chassis 104. The wheel stabilizer arrangement 110 further includes a knuckle mount 304 for mounting to the flank arm 300 and to which a wheel 202 can be rotationally mounted. The wheel stabilizer arrangement 110 also includes a stabilizer 200 for stabilizing the orientation of a wheel 202 as the wheel 202 moves though its vertical stroke relative to the chassis 104.

The stabilizer 200 includes upper and lower control arms 308A, 308B extending between the chassis 104 and the knuckle mount 304. The stabilizer 200 further includes a toe stabilizer arm 310 extending between the chassis 104 and the knuckle mount 304. The toe stabilizer arm 310 is located behind the control arms 308A, 308B and includes an airbag seat 324 from which the airbag 402 extends.

The airbag 402 is no longer mounted to the trailing flank arm 300. It is now mounted to the toe stabilizer arm 310. The first embodiment, with the airbag 402 positioned on the trailing arm flank arm 300, experienced side loading on the control arms 308 due to an inward rotational load applied from the airbag 402. This caused wear on the bushes 316 and required the constant adjustment of the turnbuckles 322 for alignment.

The present embodiment, with the airbag 402 positioned on the stabilizer arm 310, reduces these loads significantly and also allows for a simpler adjustment method, while improving the longevity, strength, weight, and simplicity of all components of the suspension system.

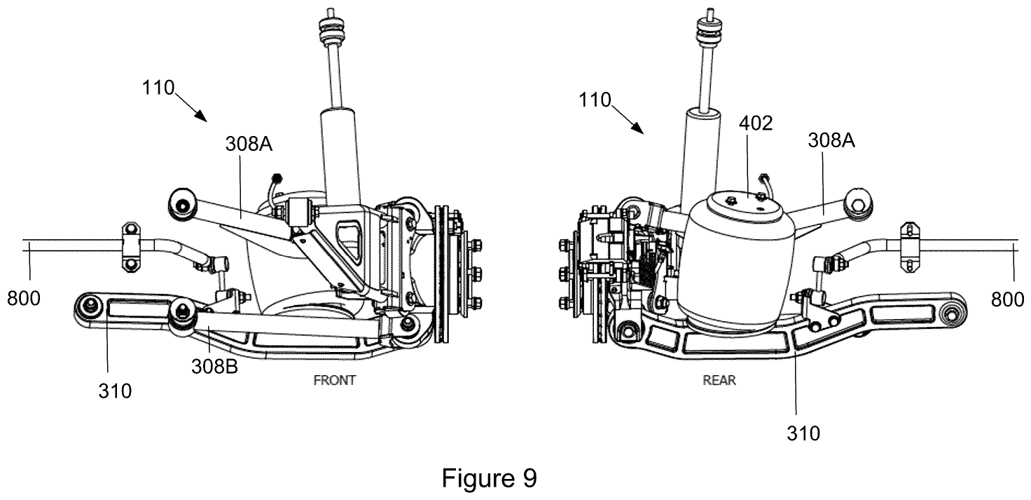

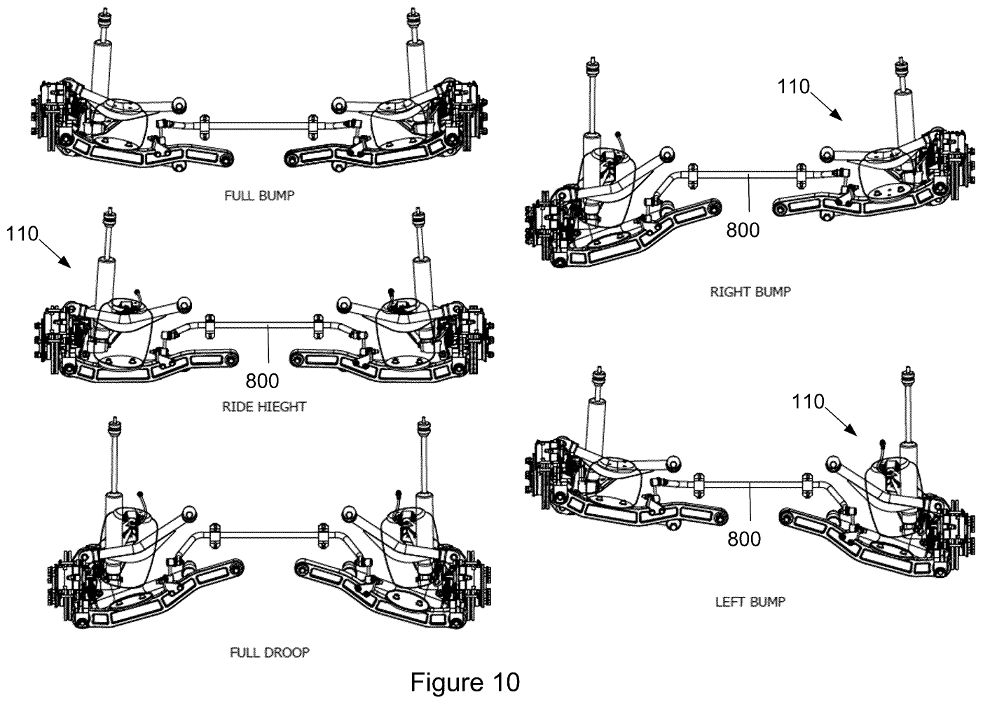

The knuckle mount 304 is fastened to the control arms 308A, 308B, the toe stabilizer arm 310 and the flank arm 300. The stabilizer 200 includes a sway bar 800 for coupling to the control arms 308A, 308B (see also FIG. 9), on either side of the camper trailer 100 which can best be seen in FIG. 10.

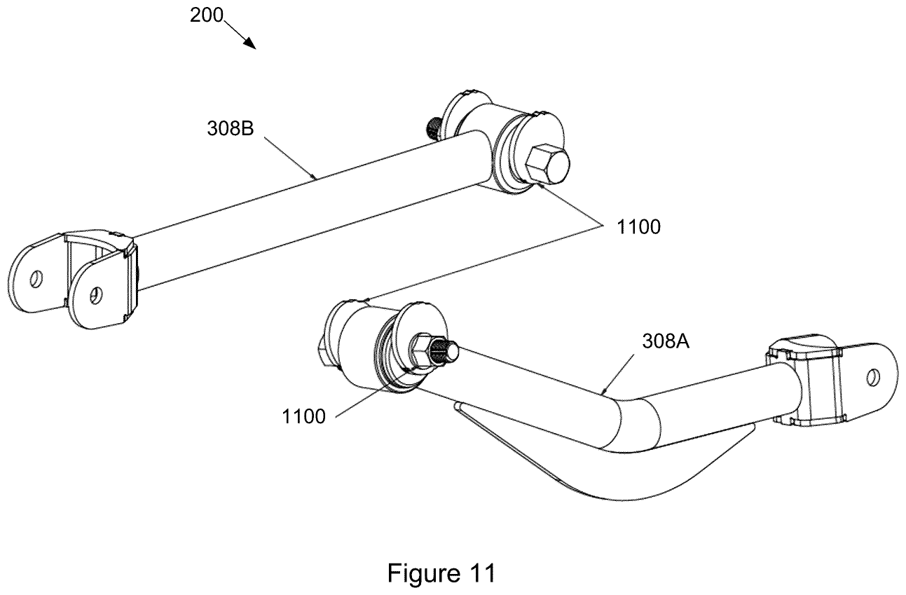

Turing to FIG. 11, the stabilizer 200 include adjuster cam arrangements 1100 for adjusting the control arms 308 to a required length. Therefore, adjustment need no longer be achieved by turnbuckle with locking nuts 322 in the centre of arms 308, 310. It is now achieved by camber adjusting bolts on the chassis side of the upper and lower control arms 308A 308B. These bolts use an offset cam to move the arm 308 in and out by turning a bolt head and are locked in place by a nut.

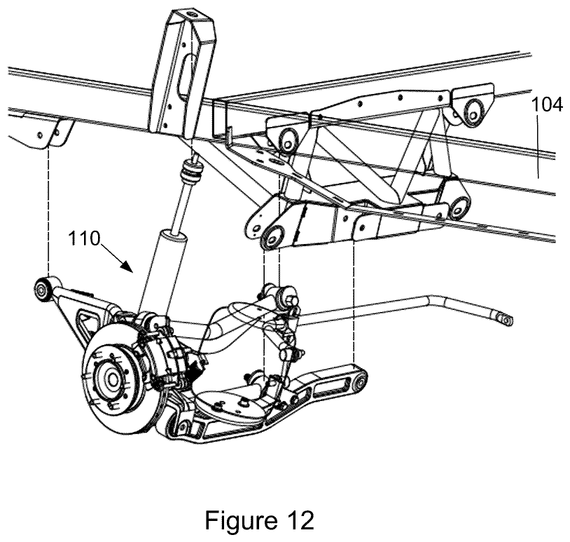

FIG. 12 shows mounting of the wheel stabilizer arrangement 110 to the chassis 104. The present invention has particular application to any form of towable accommodation, whether a camper trailer, caravan or hybrid.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A towable accommodation to be towed by an automobile, the towable accommodation including:
a chassis; and
one or more wheel stabilizer arrangements for mounting to the chassis, each wheel stabilizer arrangement including:
a flank arm for movably fastening to a flank of the chassis;
a mount for mounting to the flank arm and to which a wheel can be rotationally mounted; and
a stabilizer for stabilizing the orientation of the wheel as the wheel moves relative to the chassis.

2. The towable accommodation as claimed in claim 1, wherein the stabilizer stabilizes the wheel in a substantially vertical orientation as the flank arm moves relative to the chassis when towing the accommodation over rough terrain and through the bush.

3. The towable accommodation as claimed in claim 1, wherein each stabilizer arrangement includes a wheel hub assembly for rotationally mounting the wheel to the mount.

4. The towable accommodation as claimed in claim 1, wherein the chassis terminates in a coupler for coupling to a tow ball of the automobile and/or the mount includes a knuckle.

5. The towable accommodation as claimed in claim 1, wherein the stabilizer includes an adjuster to adjust the orientation of the wheel, the adjuster adjusting the length of one or more arms of the stabilizer and preferably including one or more cam arrangements for adjusting the arms to a required length.

6. The towable accommodation as claimed in claim 1, wherein each wheel stabilizer arrangement includes a suspension, the suspension including an airbag and a shock absorber, and preferably a gas shock absorber.

7. The towable accommodation as claimed in claim 1, wherein, an arm of the wheel stabilizer includes an airbag seat from which an airbag extends.

8. The towable accommodation as claimed in claim 1, wherein the stabilizer includes: one or more control arms extending between the chassis and the mount; and
a stabilizer arm extending between the chassis and the mount;
wherein the control arms and stabilizer arm are located behind a wheel axis.

9. The towable accommodation as claimed in claim 8, wherein the control arms include a top control arm and a bottom control arm, and the stabilizer arm is located between the top control arm and bottom control arm.

10. The towable accommodation as claimed in claim 8, wherein the stabilizer arm is located behind the control arms and/or extends outwardly beyond the control arms.

11. The towable accommodation as claimed in claim 8, wherein the mount is fastened to the control arms, the stabilizer arm and/or the flank arm.

12. The towable accommodation as claimed in claim 8, wherein the stabilizer includes a sway bar for coupling to the control arms.

13. The towable accommodation as claimed in claim 8, wherein the control arms and stabilizer arm are mounted at each end using respective resilient bushes.

14. The towable accommodation as claimed in claim 1, wherein the flank arm is pivotally fastened to the chassis, preferably using a resilient bush; and/or the mount is resiliently mounted to the flank arm, preferably using one or more resilient bushes.

15. The towable accommodation as claimed in claim 1, wherein the wheel stabilizer arrangement includes a brake arrangement.

16. The towable accommodation as claimed in claim 15, wherein the brake arrangement includes a brake disk, and a calliper for engaging with the disk.

17. The towable accommodation as claimed in claim 1, wherein the wheel hub assembly includes a hub to which the wheel is fastened.

18. The towable accommodation as claimed in claim 1, including one or two pairs of wheel stabilizer arrangements.

19. The towable accommodation as claimed in claim 1, including a non-motorised camper trailer, caravan or hybrid.

20. A towable accommodation to be towed by an automobile, the towable accommodation including:
a chassis; and
one or more wheel stabilizer arrangements for mounting to the chassis, each wheel stabilizer arrangement including a stabilizer for stabilizing the orientation of a wheel as the wheel moves relative to the chassis.
